(19) United States
(12) Patent Application Publication
(10) Pub. No.: US 2026/0027875 A1
(43) Pub. Date: Jan. 29, 2026

(54) METHOD FOR AUTOMATICALLY ADJUSTING VISOR TRANSMITTANCE MAPPING RELATIONSHIP BASED ON USER HABIT

(71) Applicant: Guangzhou Issyzone Technology Co.,Limited, GUANGZHOU (CN)

(72) Inventors: Taiping Yang, Guangzhou (CN); Zegang Ye, Guangzhou (CN); Shuneng Huang, Guangzhou (CN); Zhuo Jia, Guangzhou (CN)

(21) Appl. No.: 18/882,748

(22) Filed: Sep. 12, 2024

(30) Foreign Application Priority Data
Jul. 24, 2024 (CN) 2024109948484

(51) Int. Cl. B60J 3/04; G09G 3/38

(52) U.S. Cl. CPC B60J 3/04; G09G 3/38; G09G 2380/10

(57) ABSTRACT

The present invention discloses a method for automatically adjusting a visor transmittance mapping relationship based on a user habit, where a virtual brightness mapping table is preset, each adjustment instruction of a user is recorded, and a brightness control target under current ambient illuminance is calculated based on the instruction, and is used to automatically modify transmittance in a mapping control table. Users in different regions can constantly correct the transmittance in the mapping control table according to the ambient illuminance at the current moment during use, until calibration of the visor is in a steady state, which reduces a subsequent adjustment operation of the users, without affecting stability of a product.

### CROSS REFERENCE TO RELATED APPLICATIONS

The present application claims the priority of Chinese patent application No. 2024109948484, filed on Jul. 24, 2024, and contents of which are incorporated herein by reference.

### TECHNICAL FIELD

The present invention relates to the field of automotive part control technologies, and in particular, to a method for automatically adjusting a visor transmittance mapping relationship based on a user habit.

### TECHNICAL BACKGROUND

An electrochromic visor is an electronic visor that can automatically adjust transmittance, and a principle of the electrochromic visor is to automatically switch screen transmittance based on different light intensities, to prevent bright light from directly shining into eyes of a user. The foregoing switching logic is implemented by using a mapping table embedded in a visor controller, and the transmittance is automatically adjusted by using the mapping table associating a lumen value with the transmittance with a target of controlling the transmittance. The foregoing mapping table is determined before the visor is delivered from the factory, and a technician establishes the table based on different weather conditions and write the table into the controller.

However, an establishment process of the mapping table is limited. For example, if a manufacturer is located in a low-latitude region of China (for example, Guangdong Province), then an established mapping table is suitable for local use. However, when the product is delivered to provinces with relatively high latitudes in China, for example, Xinjiang Province and Tibet Province, or California, United States, where a latitude is relatively high (note: the light intensity can be affected by factors such as altitude, in addition to latitude), the light intensity is very strong, and the embedded mapping table is very likely to fail to meet needs of users. Different people's eyes also sense light intensities differently, some users prefer a visor with higher transmittance, while other users prefer a visor with lower transmittance, and therefore, automatic mapping cannot meet the needs of the users.

To ensure stability of a product, the manufacturer usually does not directly grant modification permission of the mapping table, but only allow the user to manually adjust current transmittance of the visor, for example, to manually adjust an original correspondence between 20000 lux and transmittance of 50% to a correspondence between 20000 lux and transmittance of 70%. However, an original mapping relationship is not changed after manual adjustment, which belongs to a temporary adjustment method, and the user needs to manually adjust the visor after each start-up, which is very tiresome.

### SUMMARY

In view of the foregoing problem, the present invention proposes a method for automatically adjusting a visor transmittance mapping relationship based on a user habit, mainly intended to resolve a problem that an existing electrochromic visor cannot automatically adjust a mapping table based on a user need.

To resolve the foregoing technical problem, a first aspect of the present invention proposes a method for automatically adjusting a visor transmittance mapping relationship based on a user habit, including the following steps:
obtaining ambient illuminance in real time and searching a mapping control table for transmittance corresponding to the ambient illuminance, where the transmittance is used to adjust an input voltage of the visor;
establishing a virtual brightness mapping table based on the mapping control table, where the virtual brightness mapping table includes multiple sets of mapping data corresponding to the mapping control table, and each set of mapping data includes a brightness level, an adjustment amount, and a final brightness level;
detecting, in real time, an adjustment instruction input by a user, overwriting an adjustment amount corresponding to ambient illuminance at a current moment with the adjustment instruction, performing an addition operation on the brightness level and the adjustment amount to obtain a modified final brightness level, and defining the modified final brightness level as a brightness control target;
searching the virtual brightness mapping table for a brightness level with the same value based on the brightness control target, and adjusting the input voltage of the visor by using target transmittance corresponding to the brightness level; and
aggregating the quantity and values of brightness control targets generated under the same ambient illuminance to determine whether the quantity and values of brightness control targets conform to a preset condition, and if yes, modifying, to the target transmittance, transmittance originally corresponding to the ambient illuminance.

In some embodiments, the adjustment amount is cleared to zero after each shutdown of the visor.

In some embodiments, a value of the adjustment instruction is an integer multiple of 1.

In some embodiments, the brightness level is nonadjustable.

In some embodiments, the preset condition includes: within a preset time range, if the quantity of brightness control targets exceeds a preset quantity, modifying, to the target transmittance, transmittance originally corresponding to the ambient illuminance.

In some embodiments, the preset time range is 4 days and the preset quantity is set to 3.

In some embodiments, the preset condition includes: if the quantity of continuously generated brightness control targets exceeds a preset value, modifying, to the target transmittance, transmittance originally corresponding to the ambient illuminance.

In some embodiments, the preset condition includes: within a preset time range, if a generation probability of the brightness control target exceeds a preset value, modifying, to the target transmittance, transmittance originally corresponding to the ambient illuminance.

A second aspect of the present invention proposes an apparatus for automatically adjusting a visor transmittance mapping relationship based on a user habit, where the apparatus includes a memory, a processor, and a communication module;
the memory is configured to store executable program code;
the processor is coupled with the memory; and
the processor invokes the executable program code stored in the memory to perform the foregoing method for automatically adjusting a visor transmittance mapping relationship based on a user habit.

A third aspect of the present invention proposes a computer-readable storage medium, where the computer-readable storage medium stores a computer instruction, and when being invoked, the computer instruction is used to perform the foregoing method for automatically adjusting a visor transmittance mapping relationship based on a user habit.

Beneficial effects of the present invention are as follows: The virtual brightness mapping table is preset, each adjustment instruction of the user is recorded, and the brightness control target under the current ambient illuminance is calculated based on the instruction, and is used to automatically modify the transmittance in the mapping control table. Users in different regions can constantly correct the transmittance in the mapping control table according to the ambient illuminance at the current moment during use, until calibration of the visor is in a steady state, which reduces a subsequent adjustment operation of the users, without affecting stability of the product.

### BRIEF DESCRIPTION OF THE DRAWINGS

FIG. 1 is a schematic flowchart of a method for automatically adjusting a visor transmittance mapping relationship based on a user habit disclosed in an embodiment of the present invention;

FIG. 2 is a schematic diagram of mapping relationships in an original mapping control table and a pre-adjustment virtual brightness mapping table;

FIG. 3 is a schematic diagram of mapping relationships in an original mapping control table and a virtual brightness mapping table during adjustment;

FIG. 4 is a schematic diagram of mapping relationships in an adjusted mapping control table and a post-initialization virtual brightness mapping table; and

FIG. 5 is a schematic structural diagram of an apparatus for automatically adjusting a visor transmittance mapping relationship based on a user habit disclosed in an embodiment of the present invention.

### DETAILED DESCRIPTION OF EMBODIMENTS

To make the purpose, the technical solution and the advantage of the present invention clearer and more explicit, content of the present invention is further described in detail below with reference to the accompanying drawings and embodiments. It should be understood that, the embodiments described here are only intended to explain the present invention rather than limit the present invention. In addition, it should also be noted that, for ease of description, only some contents related to the present invention other than all the contents are shown in the drawings.

### Embodiment 1

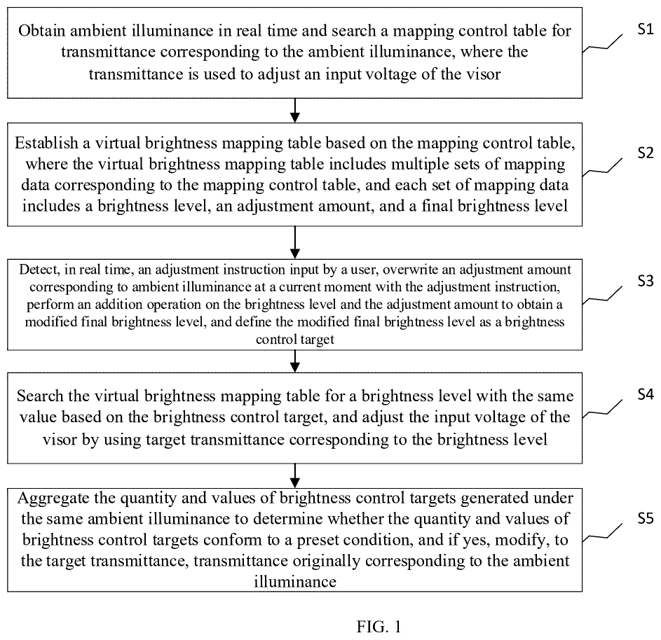

This embodiment proposes a method for automatically adjusting a visor transmittance mapping relationship based on a user habit. As shown in FIG. 1, the method includes the following steps S1 to S5:
S1. Obtain ambient illuminance in real time and search a mapping control table for transmittance corresponding to the ambient illuminance, where the transmittance is used to adjust an input voltage of the visor.

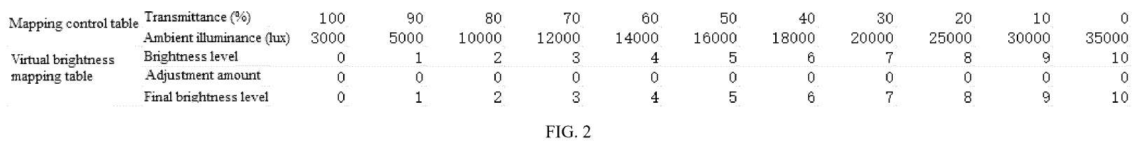

In an example, as shown in FIG. 2, an original mapping control table only includes ambient illuminance and transmittance, the ambient illuminance ranging from 3000 lux to 35000 lux is unevenly divided into 11 levels, and the transmittance ranging from 0% to 100% is evenly divided into 11 levels. For example, when the ambient illuminance is 16000 lux, the ambient illuminance corresponds to transmittance of 50%. Obviously, as the ambient illuminance is increased, the transmittance needs to be decreased until the visor completely turns black and blocks all incident light. In addition, when the ambient illuminance is below 3000 lux, there is no need to adjust the input voltage of the visor, and the transmittance is kept at 0% to save power.
S2. Establish a virtual brightness mapping table based on the mapping control table, where the virtual brightness mapping table includes multiple sets of mapping data corresponding to the mapping control table, and each set of mapping data includes a brightness level, an adjustment amount, and a final brightness level.

In an example, the virtual brightness mapping table is established based on the foregoing mapping control table. Further, referring to FIG. 2, the virtual brightness mapping table is also divided into 11 pieces of mapping data, and correspondingly, the brightness level is divided into a total of 11 levels from 0 to 10. Still taking the ambient illuminance of 16000 lux as an example, a corresponding brightness level, adjustment amount, and final brightness level are 5, 0, and 5 respectively. In this solution, the brightness level is nonadjustable and used as a constant value, initial values of adjustment amounts are all set to 0 and used as hidden variables, and the adjustment amounts are cleared to zero after each shutdown of the visor, that is, a value of zero is assigned during initialization after the system is rebooted.

It should be noted that an establishment step of the virtual brightness mapping table in this embodiment is to write the virtual brightness mapping table into a controller memory in advance before the visor is delivered from the factory, to facilitate subsequent adjustment of the user.
S3. Detect, in real time, an adjustment instruction input by a user, overwrite an adjustment amount corresponding to ambient illuminance at a current moment with the adjustment instruction, perform an addition operation on the brightness level and the adjustment amount to obtain a modified final brightness level, and define the modified final brightness level as a brightness control target.

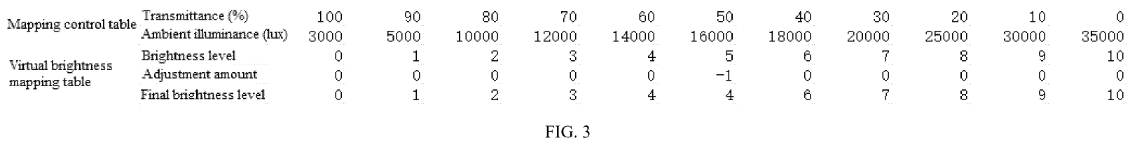

In an example, an adjustment structure such as an adjustment button or a sliding knob can be arranged on the visor, and when an adjustment instruction input by the user is recognized according to a program, a value of the adjustment instruction is an integer multiple of 1, for example, −1, −2, −3, 1, 2, and 3. In an example, as shown in FIG. 3, if the current ambient illuminance is 16000 lux, assuming that the adjustment instruction input by the user is −1, it is indicated that the user still needs to improve the transmittance of the visor under 16000 lux, the brightness level and adjustment amount are 5 and −1 respectively, and the calculated final brightness level is 4, which is used as the brightness control target.
S4. Search the virtual brightness mapping table for a brightness level with the same value based on the brightness control target, and adjust the input voltage of the visor by using transmittance corresponding to the brightness level.

In an example of the solution, because the brightness control target is designed to increase (or decrease in another adjustment task, which specifically depends on an expectation of the user) the transmittance of the visor, still referring to FIG. 3, the virtual brightness mapping table is searched for the brightness level of the same brightness of 4, and it can be seen that the brightness level is 4 under the ambient illuminance of 14000 lux, and at this moment, the corresponding transmittance is 60%. In the adjustment task, the transmittance of 60% is used as the adjustment target to adjust the input voltage of the visor, and after adjustment, the transmittance of the visor is adjusted from 50% to 60%, that is, the transmittance is increased; and a brightness level of a screen is correspondingly reduced by 1 level, that is, changed from 5 to 4.

It should be noted that during the first adjustment, because initial values of the adjustment amounts are all zero, all the brightness levels and final brightness levels in the virtual brightness mapping table are all equal. However, in step S4, the brightness levels other than the final brightness levels need to be searched for the brightness control target. Assuming that in the previous round of adjustment task, there is an adjustment under the ambient illuminance of 14000 lux, final brightness corresponding to 14000 lux is adjusted, the value corresponds to transmittance of another level, and therefore, the value is no longer suitable to be used as a search target in this round of adjustment task.
S5. Aggregate the quantity and values of brightness control targets generated under the same ambient illuminance to determine whether the quantity and values of brightness control targets conform to a preset condition, and if yes, modify, to the target transmittance, transmittance originally corresponding to the ambient illuminance.

In a start-up process of the visor, a light intensity of the sun always changes, and therefore, the adjustment task needs to be based on ambient illuminance detected at a current moment. As described in step S3 to step S5, the current ambient illuminance needs to be determined during detection, to ensure that a target of the adjustment task is based on the current moment and used to adjust the mapping control table. The modified mapping control table is used as the basis for a subsequent additional round of adjustment task. A main reason why manufacturers do not allow the user to adjust the mapping control table is that an incorrect operation of the user may cause a large deviation to the mapping relationship in the mapping control table. For example, once a vehicle leaves a tunnel, light changes sharply, and in this case, the user may immediately adjust the visor to be fully black, but in fact, the ambient illuminance obtained by the sensor at this moment is far less than 35000 lux, and therefore, if the user is freely allowed to make an adjustment, the stability of the product is greatly affected. In addition, in the solution of the present invention, the adjustment instruction of the user is detected through a specific condition, to reduce impact of the incorrect operation of the user. Therefore, on the premise that adjustment of the mapping control table is conditionally allowed, the stability of the product is not affected.

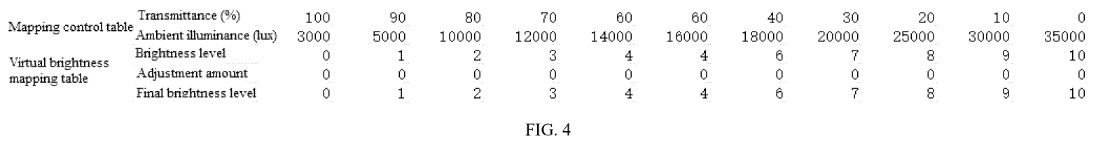

Three different preset conditions are provided below for illustration:
(1) The preset condition includes: within a preset time range, if the quantity of brightness control targets exceeds a preset quantity, modifying, to the target transmittance, transmittance originally corresponding to the ambient illuminance. Based on the foregoing quantity of brightness control targets, an alternative solution of this solution is provided, where the preset time range is 4 days and the preset quantity is set to 3. Assuming that the time is 4 days and the ambient illuminance is 16000 lux, if values of more than 3 adjustment instructions input by the user are all −1, brightness control targets calculated in step S4 are all 4, and it can be determined that under the ambient illuminance of 16000 lux, the transmittance of the visor actually required by the user is 60%, transmittance of 50% originally corresponding to the ambient illuminance is excessively low, and therefore, the transmittance of 50% corresponding to the ambient illuminance of 16000 lux is changed to the target transmittance of 60%. Further, the corresponding brightness level and final brightness level under the ambient illuminance of 16000 lux are modified from level 5 to level 4. As shown in FIG. 4, in this example, the same set of mapping data (except that the ambient illuminance is different) is used under the ambient illuminance of 16000 lux and the ambient illumination of 14000 lux.
(2) The preset condition includes: if the quantity of continuously generated brightness control targets exceeds a preset value, modifying, to the target transmittance, transmittance originally corresponding to the ambient illuminance. In an example, the preset value is set to 4 to conditionally count the brightness control targets after each adjustment. For example, under the ambient illuminance of 16000 lux, assuming that brightness control targets (final brightness levels) are all 4 after 4 consecutive adjustments of the user (if there is a brightness control target with another value in the counting process of the brightness control targets, assuming that the value is 3, aggregation of the brightness control targets with the value of 4 is interrupted), the original mapping relationship is changed and the transmittance corresponding to the ambient illuminance of 16000 lux is modified from 50% to 60%.
(3) The preset condition includes: within a preset time range, if a generation probability of the brightness control target exceeds a preset value, modifying, to the target transmittance, transmittance originally corresponding to the ambient illuminance. Likely, an activation function can be set. Assuming that the ambient illuminance is 16000 lux, when the user consecutively sets the brightness control targets multiple times, the preset value is set to 74%, 3 brightness control targets are set to 4, and 1 brightness control target is set to 3, a probability of setting the brightness control target to the level 4 is greater than 74%, and the transmittance corresponding to the ambient illuminance of 16000 lux is modified from 50% to 60%.

### Embodiment 2

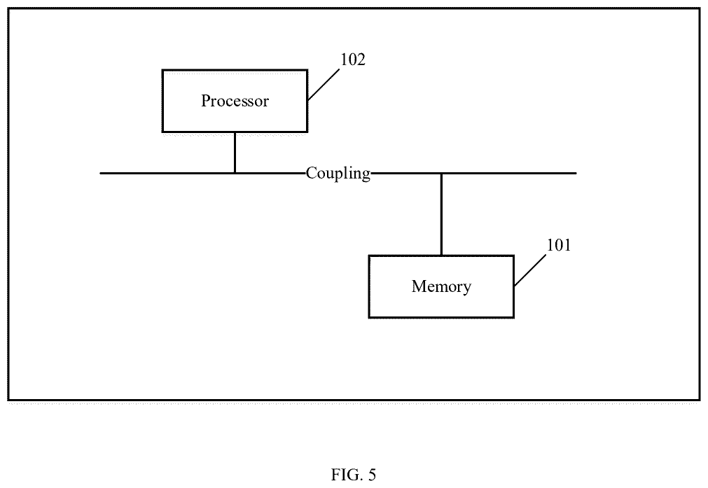

Referring to FIG. 5, FIG. 5 is a schematic structural diagram of another apparatus for automatically adjusting a visor transmittance mapping relationship based on a user habit disclosed in an embodiment of the present invention. As shown in FIG. 5, a control platform may include:
a memory 101, configured to store executable program code; and
a processor 202, coupled with the memory 101, where
the processor 202 invokes the executable program code stored in the memory 101, to perform steps in the method for automatically adjusting a visor transmittance mapping relationship based on a user habit described in Embodiment 1.

### Embodiment 3

This embodiment of the present invention discloses a computer program product, where the computer program product includes a non-transitory computer-readable storage medium storing a computer program, and the computer program can be run to enable a computer to perform steps in the method for automatically adjusting a visor transmittance mapping relationship based on a user habit described in Embodiment 1.

The foregoing apparatus embodiments are only exemplary, the modules described as discrete components may or may not be physically separated, and components shown as modules may or may not be physical modules, that is, the components may be located at one area, or may also be distributed on multiple network modules. Some or all of the modules may be selected based on actual requirements to achieve the objectives of the solutions of the embodiments. Persons of ordinary skills in the art can understand and implement the solutions without creative efforts.

Through specific description of the foregoing embodiments, persons skilled in the art can clearly understand that the embodiments can be implemented via software in combination with a necessary general-purpose hardware platform, or via hardware. Based on such understanding, essence or parts of the foregoing technical solutions that contribute to the prior art may be embodied in a form of a software product. The computer software product may be stored in a computer-readable storage medium, and the storage medium includes Read-Only Memory (ROM), Random Access Memory (RAM), Programmable Read-only Memory (PROM), Erasable Programmable Read-Only Memory (EPROM), One-time Programmable Read-Only Memory (OTPROM), Electrically-Erasable Programmable Read-Only Memory (EEPROM), Compact Disc Read-Only Memory (CD-ROM) or another optical disc memory, a magnetic disk memory, a cassette memory, or any other computer-readable medium that can be used to carry or store data.

Finally, it should be noted that, disclosed embodiments of the method for automatically adjusting a visor transmittance mapping relationship based on a user habit disclosed in the embodiments of the present invention are only preferred embodiments of the present invention, and are only intended to describe other than limit the technical solutions of the present invention. Although the present invention is described in detail with reference to the foregoing embodiments, persons of ordinary skills in the art should understand that they may still make modifications to the technical solutions described in the foregoing embodiments or make equivalent replacements to some technical features therein. Despite these modifications and replacements, the essence of the corresponding technical solutions shall not depart from the spirit and scope of the technical solutions of the embodiments of the solutions.

What is claimed is:

1. A method for automatically adjusting a visor transmittance mapping relationship based on a user habit, comprising the following steps:
obtaining ambient illuminance in real time and searching a mapping control table for transmittance corresponding to the ambient illuminance, wherein the transmittance is used to adjust an input voltage of the visor;
establishing a virtual brightness mapping table based on the mapping control table, wherein the virtual brightness mapping table comprises multiple sets of mapping data corresponding to the mapping control table, and each set of mapping data comprises a brightness level, an adjustment amount, and a final brightness level;
detecting, in real time, an adjustment instruction input by a user, overwriting an adjustment amount corresponding to ambient illuminance at a current moment with the adjustment instruction, performing an addition operation on the brightness level and the adjustment amount to obtain a modified final brightness level, and defining the modified final brightness level as a brightness control target;
searching the virtual brightness mapping table for a brightness level with the same value based on the brightness control target, and adjusting the input voltage of the visor by using target transmittance corresponding to the brightness level; and
aggregating the quantity and values of brightness control targets generated under the same ambient illuminance to determine whether the quantity and values of brightness control targets conform to a preset condition, and if yes, modifying, to the target transmittance, transmittance originally corresponding to the ambient illuminance.

2. The method for automatically adjusting a visor transmittance mapping relationship based on a user habit according to claim 1, wherein the adjustment amount is cleared to zero after each shutdown of the visor.

3. The method for automatically adjusting a visor transmittance mapping relationship based on a user habit according to claim 1, wherein a value of the adjustment instruction is an integer multiple of 1.

4. The method for automatically adjusting a visor transmittance mapping relationship based on a user habit according to claim 1, wherein the brightness level is nonadjustable.

5. The method for automatically adjusting a visor transmittance mapping relationship based on a user habit according to claim 1, wherein the preset condition comprises: within a preset time range, if the quantity of brightness control targets exceeds a preset quantity, modifying, to the target transmittance, transmittance originally corresponding to the ambient illuminance.

6. The method for automatically adjusting a visor transmittance mapping relationship based on a user habit according to claim 5, wherein the preset time range is 4 days and the preset quantity is set to 3.

7. The method for automatically adjusting a visor transmittance mapping relationship based on a user habit according to claim 1, wherein the preset condition comprises: if the quantity of continuously generated brightness control targets exceeds a preset value, modifying, to the target transmittance, transmittance originally corresponding to the ambient illuminance.

8. The method for automatically adjusting a visor transmittance mapping relationship based on a user habit according to claim 1, wherein
the preset condition comprises: within a preset time range, if a generation probability of the brightness control target exceeds a preset value, modifying, to the target transmittance, transmittance originally corresponding to the ambient illuminance.

9. An apparatus for automatically adjusting a visor transmittance mapping relationship based on a user habit, wherein the apparatus comprises a memory, a processor, and a communication module;
the memory is configured to store executable program code;
the processor is coupled with the memory; and
the processor invokes the executable program code stored in the memory to perform the method for automatically adjusting a visor transmittance mapping relationship based on a user habit according to claim 1.

10. A computer-readable storage medium, wherein the computer-readable storage medium stores a computer instruction, and when being invoked, the computer instruction is used to perform the method for automatically adjusting a visor transmittance mapping relationship based on a user habit according to claim 1.
